(19) United States
(12) Patent Application Publication
(10) Pub. No.: US 2012/0324436 A1
(43) Pub. Date: Dec. 20, 2012

(54) METHOD OF UPDATING VERSIONED SOFTWARE USING A SHARED CACHE

(76) Inventor: Aleksandar Milenovic, Athlone (IE)

(21) Appl. No.: 13/516,031

(22) PCT Filed: Dec. 15, 2009
(86) PCT No.: PCT/EP09/67158

§ 371 Date: Aug. 28, 2012

(51) Int. Cl. G06F 9/44

(52) U.S. Cl. 717/170

(57) ABSTRACT

The present invention relates to the replacement of an existing version of versioned software with a new version of versioned software using a shared cache, in which the software is versioned and each version of the software has an associated area within the shared cache for storing data, including at least software identification and version information. In a first step of a data store change process a new version data store is created, having a new version data store schema, containing data derived from the data in the existing version data store at an initial point at the start of a data migration phase. In a second step of the data store change process change, information stored by the existing version software in the shared cache and relating to changes to the existing version data store made by the existing version software during the step of creating the new version data store, is converted to replay information relating to corresponding changes to the new version data store. In a third step of the data store change process the new version data store is updated using the replay information during a replay phase of the data store change process.

### TECHNICAL FIELD

The present invention relates to the replacement of an existing version of versioned software with a new version of versioned software, for example during a software update process.

### BACKGROUND

Many software components have associated data stores in which data that is used by, generated by or processed by the software components is stored. Typically, a data store may be a database, although other forms of data store can also be envisaged by a skilled person. A data store has a logical structure, or schema, which defines for example which information or attributes are stored relating to an object. Each object has associated data stored in accordance with the schema.

A common situation arises when the software is to be updated. In addition to the new software, a new data store is also typically required, and the new data store may have a different schema from the existing data store. Generally the new version software takes over the operation of the existing version software and as a result the data in the existing data store must be converted to the new data store schema and stored in the new data store before the new version software is able to become operational. There are many methods of software update available currently.

In a split cluster arrangement two servers having cluster middleware are provided with storage discs that are mirrored and shared. This arrangement allows software on a second clustered server to be started if a hardware fault of the first master server is detected. During a process to upgrade the software the discs must be split to convert the data and during this period the data cannot be changed otherwise inconsistencies will occur when the upgraded host comes to be promoted as master server in the cluster. This period of data change freeze can take a long time, even hours, and system has seen as functionally unavailable during this period.

In another upgrade method another host is installed. The data from the running host is backed up. Then data is restored and conversion is started. After conversion, the original host is shut down and another promoted as main host. Once again, during data conversion, applications on the original system cannot change the data.

From the above description it can be seen that, generally, the software components of the existing software version must be stopped and new instances of the new software version must be started. The new version software then creates a new version data store, with associated schema, and populates the new version data store with data from the existing version data store. Once the new version data store has been populated with the data from the existing version data store, the new version software can start operating, and the existing version software can be removed.

However, during the period in which the software components of the existing version are stopped and new instances of the new version software started, the software will be out of service. In addition, during the period of conversion of the existing version data store to the new version data store, the data in the existing version of the data store must not change. Therefore, software applications that change data in the data store are unable to access the data store during this period, and therefore are functionally unavailable.

Furthermore, in some upgrade methods complex and costly hardware infrastructure is required to facilitate the upgrade process, thus increasing the system cost. Moreover, in systems in which mirrored discs must be split during an upgrade process, for example the split cluster systems described above, the splitting of the discs results in increased complexity and risk of error in the upgrade process.

The present invention seeks to alleviate at least some of the problems in the prior art, and to provide a new method of replacing an existing version of versioned software with a new version of versioned software.

### SUMMARY

According to a first aspect of the invention, there is provided a method of replacing existing version software and an associated existing version data store with new version software and an associated new version data store using a shared cache, in which the software is versioned and each version of the software has an associated area within the shared cache for storing data, including at least software identification and version information. In a first step of a data store change process of the method, a new version data store is created, having a new version data store schema, containing data derived from the data in the existing version data store at an initial point at the start of a data migration phase. In a second step of the data store change process of the method, change information, stored by the existing version software in the shared cache and relating to changes to the existing version data store made by the existing version software during the step of creating the new version data store, is converted to replay information relating to corresponding changes to the new version data store. In a third step of the data store change process of the method, the new version data store is updated using the replay information during a replay phase of the data store change process.

According to a second aspect of the invention there is provided a machine-readable medium comprising instructions which cause a processor to perform a method of replacing existing version software and an associated existing version data store with new version software and an associated new version data store using a shared cache, in which the software is versioned and each version of the software has an associated area within the shared cache for storing data, including at least software identification and version information. In a first step of a data store update process of the method, a new version data store, having a new version data store schema, is created containing data derived from the data in the existing version data store at an initial point at the start of a data migration phase. In a second step of the data store change process of the method, change information, stored by the existing version software in the shared cache and relating to changes to the existing version data store made by the existing version software during the step of creating the new version data store, is converted to replay information relating to corresponding changes to the new version data store. In a third step of the data change process of the method, the new version data store is updated using the replay information during a replay phase of the data store change process.

According to a third aspect of the invention there is provided a network element having a versioned software program stored on a machine-readable medium. The network element also has a data store associated with the versioned software program stored on a storage medium. The network element also has a cache area associated with the software program formed on a cache storage medium, the cache area having data, including at least software identification and version information of the associated software program, stored therein and the cache area being part of a shared cache. The versioned software comprises a create new data store function operable during a data store change process of a method of replacing existing version software and an associated existing version data store with the versioned software program and the data store associated with the versioned software program to create the data store, the data store having a data store schema, the data store containing data derived from the data in the existing version data store at an initial point at the start of a data migration phase. The versioned software also comprises a create replay information function operable during the data store change process to convert change information, stored by the existing version software in the shared cache and relating to changes to the existing version data store made by the existing version software during the step of creating the data store, to replay information relating to corresponding changes to the data store. The versioned software also comprises an update data store function operable during the data store change process to update the data store using the replay information during a replay phase of the data store change process.

The method of the invention enables the existing software to continue to provide the existing software functionality to an end user during an initialisation period of the new version software, leading to a reduction in the time that the software functionality or access to system data is unavailable compared with systems in which the software system functionality or access to system data is suspended during the initialisation period of the new version software.

### BRIEF DESCRIPTION OF THE DRAWINGS

The invention will now be described by way of example with reference to the accompanying drawings:

FIG. 1 is a schematic diagram of apparatus for implementing one embodiment of the invention;

FIG. 2 shows the different software operational states of the software programs during the method of embodiments of the invention;

FIG. 3 is a flow chart showing an exemplary method of updating versioned software in accordance with an embodiment of the invention; and

FIG. 4 illustrates the operation of an embodiment of the invention.

### DETAILED DESCRIPTION

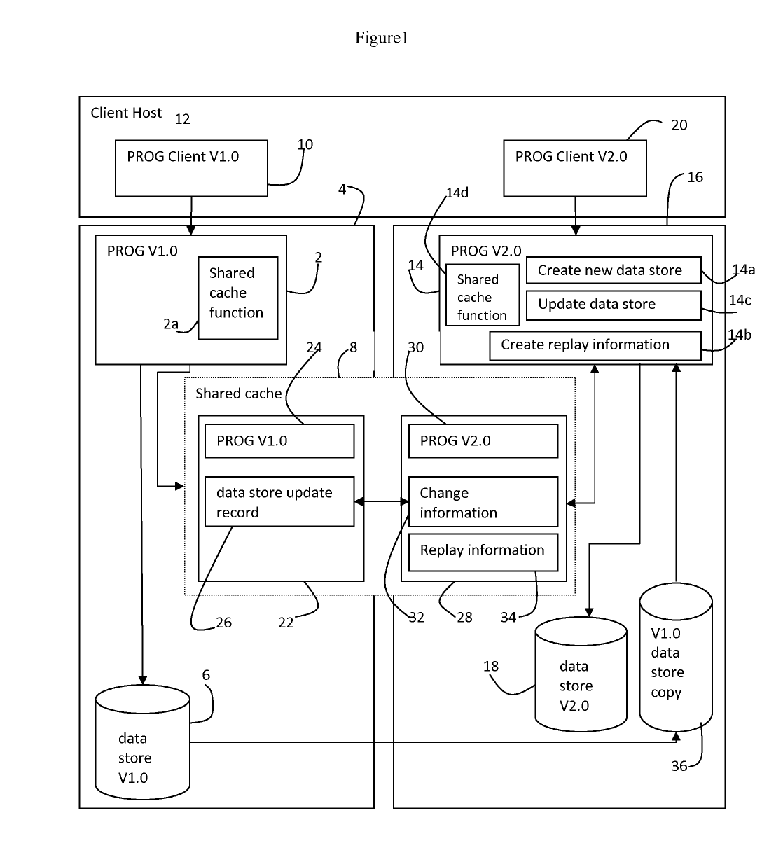

Embodiments of the invention will now be described with reference to FIGS. 1-4 of the accompanying drawings.

In one embodiment the invention relates to a method of replacing an existing version software program, with a new version software program using a shared cache.

The exemplary described embodiment uses a shared cache during the replacement of the existing version software with the new version software. Shared cache functionality typically enables a number of entities, in this case the existing version software and the new version software, to become a member of a group or cluster. Each member of the group or cluster may receive messages sent to it by another member and is able to share application data with other members of the group.

The term “shared cache” as used herein is intended to encompass all such mechanisms allowing automatic data sharing and messaging between different software programs, in some situations on different host computers.

The shared cache functionality may be implemented in different ways, as will be apparent to a skilled person. A number of products are currently available to implement this functionality: for example Open Source products Shoal (https://shoal.dev.java.net/) and Memcached, (http:www.danga.com/memcached/); and a commercially available product Gigaspace XAP, (http://www.gigaspaces.com/datagrid). The present invention is not, however, limited to the use of these products and any arrangements providing shared cache functionality may be used.

The shared cache functionality is provided by respective shared cache functions in the new version software and in the existing version software that communicate with each other to create the described shared cache functionality for the shared cache.

In embodiments of the invention the new version software program may be installed on the same computer host as the existing version software program or may be installed on a different computer host. Typically in some embodiments client software may be provided for enabling a user to interact with the software program. Again, the client software may be installed on the same computer host or on different computer host in different embodiments of the invention.

In the exemplary embodiments an existing version software program is installed and operating when a new version software program is installed. Typically, the new version software will be a new release of the existing version software, and in this situation the invention provides a new method of updating software. The invention is broadly applicable to software of many different types, and is particularly suitable for applications in which the time during which the software program is unavailable during a software program upgrade is to be kept to a minimum.

The invention may be applicable in some embodiments to remote upgrade of software elements. One such application is the upgrade of software program elements in a communications network. However, it will be clear that the invention is not limited to this application but instead is broadly applicable to the replacement or upgrade of many software program elements.

The disclosed methods enable the existing version software program to continue operating and providing the software program functionality during a period immediately after the installation of the new version software program, until the new version software program is ready to provide software program functionality. Thus the time during which the software program functionality is unavailable is minimised.

FIG. 1 is a schematic diagram of apparatus for implementing one embodiment of the invention.

An existing version software program (PROGv1.0) 2 is installed on and is operated on a computer host 4. An example of a software program to which this invention can be applied is a network controller within a network management system of a communications network. Typically the network controller will be installed on a network management server. However, as will be appreciated by a skilled person, the invention may be applied to other software programs.

Existing version software program 2 is operatively coupled to an associated existing version (v1.0) data store 6 on the host computer 4, for storing information created by, or used by, existing version software program 2. The existing version data store 6 may be a database or may be file systems or any other data store as will be apparent to a skilled person. In the exemplary embodiment, the existing version data store 6 is a database.

The existing version software program 2 has a shared cache function 2a which is operable to attach to a shared cache 8. The shared cache 8 is a logical construction, created by shared cache function 2a and shared cache function 14d of new version software program 14, as will be described in more detail hereafter. The existing software program 2 is able to store information in the shared cache 8, as is known by a skilled person.

An existing version software program client (PROG Client v1.0) 10 is also provided on a client host 12 operatively coupled to existing version software program 2. Existing version client 10 operates to control existing version software program 2 and to receive information from existing version software program 2, and enables a user to interact with and control the existing version software program 2, as is well known to a skilled person. Client host 12 is shown separate from host 4 since the client host 12 may be remote from the host 4, as will be known to a skilled person, but in some embodiments client host 12 may be part of host 4.

New version software program 14 is installed on a computer host 16. The new version software program 14 comprises at least the following functions: create new data store function 14a; create replay information function 14b; and update data store function 14c; and shared cache function 14c.

As will be apparent to a skilled person, the new version software program will also have additional functions relating to the detailed functionality of the software program operation, which are not relevant to the present invention and therefore have been omitted. In addition it is envisaged in some embodiments that the new version software program will also be provided with a master scheduling function that is operational at least during the initial period of operation after installation of the software and is responsible for invoking functions 14a-14d to carry out the method of embodiments of the invention. However, the master scheduling function has been omitted for clarity.

As will be apparent to a skilled person, the described functionality may be achieved using greater or fewer function modules, and the internal structure of software functional modules or arrangement of functionality within the software is a matter of design choice by a skilled person.

Although computer host 16 is shown and described as separate from host 4, it will be apparent that the new version software program 14 may equally be installed on host 4 in alternate embodiments of the invention.

New version software program 14 is operatively coupled to an associated new version data store 18 on computer host 16 for storing information created by, or used by, the new version software program 14 during operation, in a similar manner to existing version data store 6 provided for existing version software program 2. Again, the new version data store 18 may be a database or file system or any other data store as will be apparent to a skilled person. In the exemplary embodiment, the new version data store 18 is a database.

The shared cache function 14d is operable to attach to the shared cache 8, and is able to store information in the shared cache 8, and to read information from the shared cache 8, as is known by a skilled person.

A new version software program client (PROG Client v2.0) 20 is also provided on a client host 12, and is operatively coupled to new version software program 14. New version client 20 operates to control new version software program 14 and to receive information from new version software program 14 and enables a user to interact with and control the new version software program 14, as is well known to a skilled person.

Within the shared cache 8 the existing version software program 2 is provided with an associated existing version shared cache area 22, which in the illustrated embodiment is formed in a memory or storage area of the computer host 4. The existing version shared cache area 22 is used to store both State and Action information relating to the existing version software program 2. Therefore within the existing version shared cache area 22 there is at least: an area 24 containing information relating to the identity and version of the existing version software program 2 (State information); and an area 26 containing existing data store update record information (Action information). In addition, other information, such as an address (for example the Internet Protocol address) for the existing version data store may also be stored in existing version shared cache area 22 (not shown in FIG. 1).

Within the shared cache 8 the new version software program 14 is also provided with an associated new version shared cache area 28, which in the illustrated embodiment is formed in a memory or storage area of the computer host 16. The new version shared cache area 28 is used to store both State and Action information relating to the new version software program 2. Therefore within the new version shared cache area 28 there is at least: an area 30 containing information relating to the identity and version of the associated new version software program 14; an area 32 containing change information; and an area 34 containing replay information.

As described above, the shared cache functionality, implemented by the respective shared cache functions 2a and 14d in the existing version software program and the new version software program, enables data stored in one shared cache area to be copied to another shared cache area automatically. This functionality is applied in the described embodiment to copy existing data store update record information stored in area 26 of the existing version shared cache area to area 32 of the new version shared cache area as change information, as will be described in more detail in the following description.

In addition, as will be explained in more detail below, messages can be sent between the new version software program and the existing version software program using the shared cache functions 2a and 14d.

Finally an existing version (v1.0) data store copy 36 is provided on the host 16, which is formed as a copy of the existing version data store 6, as will be explained in more detail hereafter. The data store copy 36 is coupled to new version software program 14 to provide data thereto.

As will be clear from the above description, software programs using the method of the invention are versioned and are aware of their program identity and version identity. Thus in the described embodiment the existing version shared cache area 22 and the new version shared cache area 28 have respective areas 24, 30 for storing program and respective version identity information.

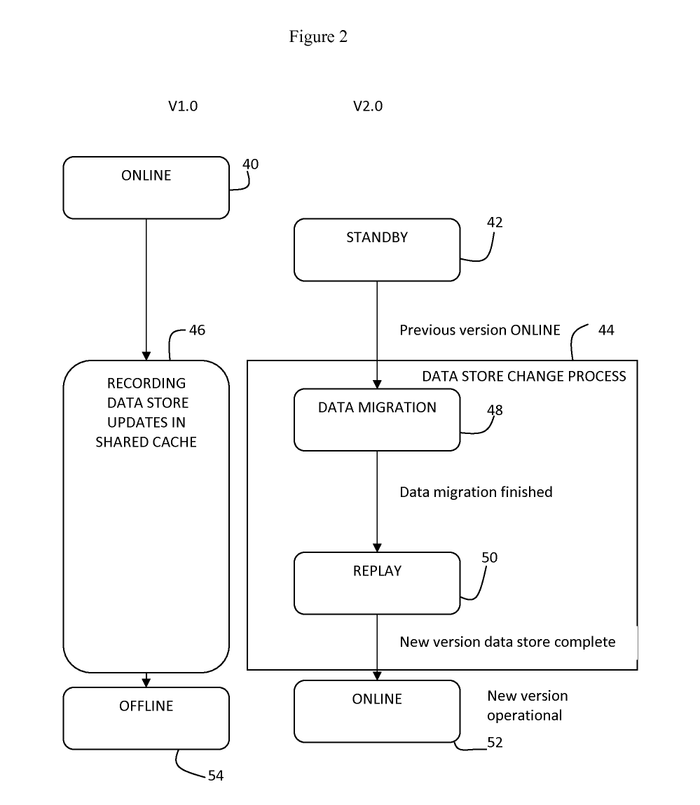

The different software operational states of the software programs during the replacement of versioned software in accordance with embodiments of the invention will now be explained with reference to FIG. 2.

In FIG. 2 the existing version software program 2 is operating in an online state 40, until a new version of the same software 14 is installed in a standby state 42. The new version software program 14 determines the existence of existing version software program 2 and so the new version software program 14 enters a data store change process 44 (the situation when no existing version software program is detected is not shown in FIG. 2, for clarity).

The existing version software program 2 continues to operate and provide the software functionality. During the data store change process 44, the existing version software program 2 is in a recording data store update state 46 in which information relating to changes in the existing data store is recorded. When the data store is a data base the actions that can be recorded by the existing version software program 2 are Create, Delete, and Update. In embodiments of the invention it is necessary to record only the last action in the shared cache and each new action stored can overwrite the previous action, as will be explained in more detail hereafter and it is not necessary to record a log or a history of all updates in the shared cache.

During the data store change process 44 the new version software program 14 firstly enters a data migration state 48 in which a new version data store 18 is created and populated with data from the existing version data store 6 at the start of the data store change process. The new version software also determines what updates to the new version data store are required to reflect changes in the existing version data store 6 since the start of the data store change process.

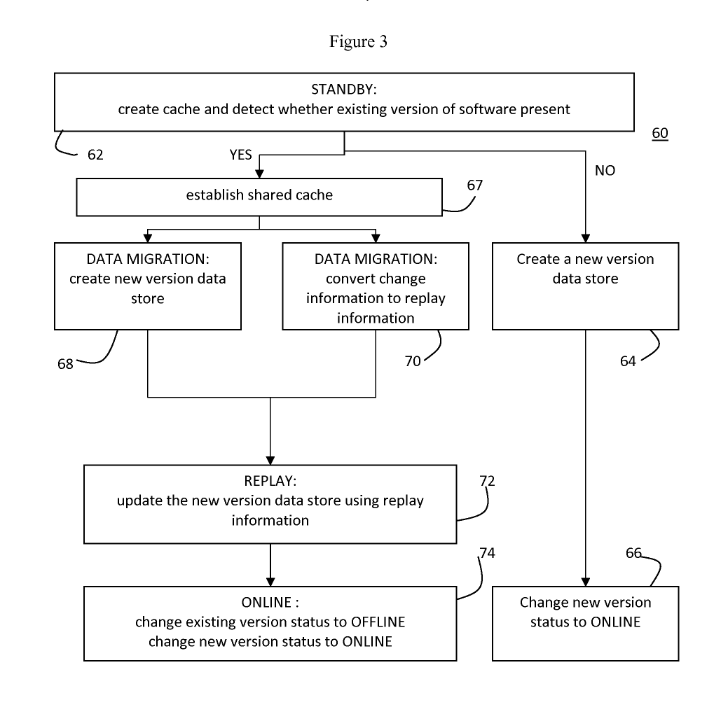

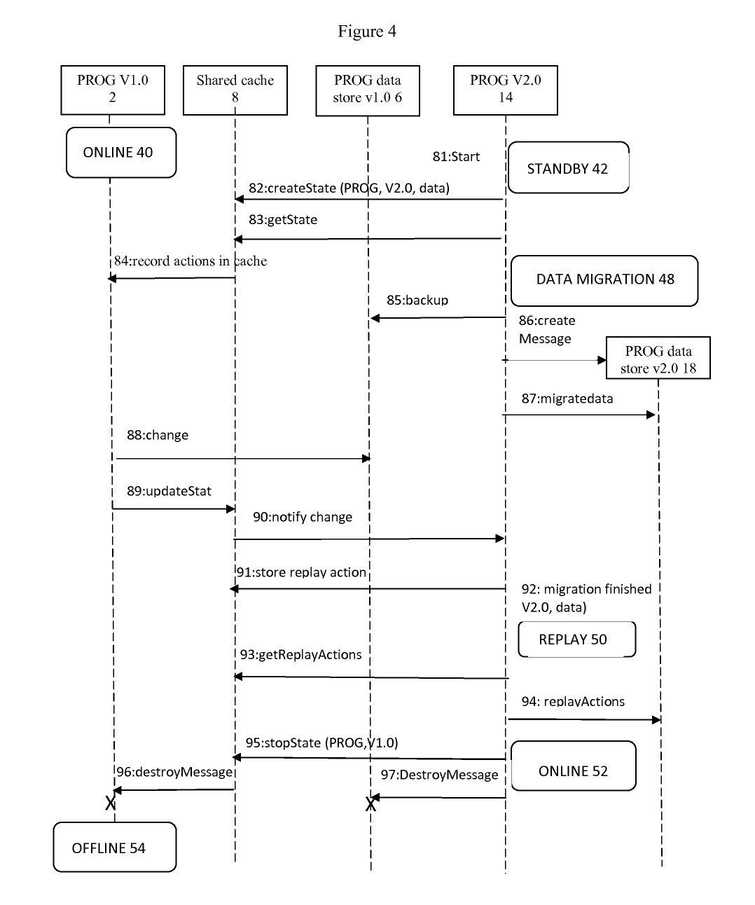

Once data migration has finished, the new version software program 14 enters a replay state 50 in which the new version data store 18 is updated corresponding to changes to the existing version data store 6 since the start of the data store change process. The action carried out by new version software program 14 during the data migration state 48 and the replay state 50 will be described in more detail with reference to FIGS. 3 and 4.

Once the new version data store is complete and ready for use at the end of the replay state 50, the new version software program 14 transitions to an online state 52 while the existing version software program 2 transitions from recording state 46 to an offline state 54.

Thus, after installation the new version software program 14 starts in standby state 42 and moves through a data migration state 48 to a replay state 50 and then to an online state 52. In the meantime, the existing version software program 2, which was in an online state 40 initially, is in a recording state 46 during the data store change process 44. Once the data store change process 44 is completed the existing version software program 2 transitions to an offline state 54 as the new version software program 14 transitions from the replay state 50 to online state 52

The method of an exemplary embodiment will now be described with reference to FIG. 3, which shows an exemplary method of updating versioned software 60.

At the start of method 60 of updating versioned software, the new version software program 14 is in a standby state 42. As shown in FIG. 3, the new version software program 14 detects whether an existing version of the software is present, step 62.

This step is carried out using the shared cache functionality provided by the shared cache function 14d in the exemplary embodiment. Thus the shared cache function establishes the new version shared cache area 28 within a suitable storage area in host 16. The shared cache function 14d then searches for another shared cache function having the same identity information (PROG) but a different version number (version 1.0 instead of v2.0).

If an existing version of the software is not present (not shown in FIG. 2), step 62-no, the new version software program 14 creates a new version data store 18 in step 64 and changes the new version status to online in step 66 of method 60, as is conventional.

However, if, as in the illustrated embodiment, shared cache function 2a having the same identity information (PROG) but a different version number (version 1.0 instead of v2.0) is detected it is determined that an existing version of the software is already present, step 62-yes. When it is determined that an existing version of the software is already present, step 62-yes the shared cache function 14d establishes a shared cache 8 with shared cache function 2a, step 67. The shared cache functions 2a, 14d are able to share data in their respective shared cache areas 22 and 28 and access data stored in any shared cache area. In addition the shared cache functions are able to send instructions to each other. In the described embodiment the shared cache function 14d requests that data stored in the area 26 for storing updates to the existing data store 6 is copied by shared cache function 2a to shared cache function 14d, and stored in change area 32 of new version shared cache area 28.

Thereafter the new version software program 14 enters a data migration creation step 68 and a data migration conversion step 70, which are carried out simultaneously in the illustrated embodiment.

In the data migration creation step 68, create new data store function 14a creates a new version data store 18. The new version data store 18 may have a logical structure or schema different from the existing version data store 6 but should be populated with the data from the existing version data store 6. Therefore in the data migration creation step 68 in this embodiment create new data store function 14a firstly creates an existing version data store copy 36 by copying the existing version data store 6 at the beginning of the data migration phase. The copying may be accomplished in embodiments of the invention by the shared cache function 14d accessing, via the shared cache function 2a, address information of the existing version data store 6 stored in existing version shared cache area 22 (not shown), and then passing the address to the create new data store function 14a. The create new data store function 14a also creates the new version data store 18 and populates the new version data store 18 with the data from the existing version data store copy 36. In some embodiments of the invention it is not necessary to create an existing version data store copy 36, and the new version data store 18 may be populated with data taken directly from the existing version data store 6.

During the data migration creation step 68, when create new data store function 14a is creating the new version data store 18, as described above, the existing version software program 2 is recording update information relating to updates to the existing version data store 6 in the area 26 of the existing version shared cache area 22. Owing to the operation of the shared cache functionality provided by shared cache function 2a and shared cache function 14d, as described above, update information stored in area 26 of the existing version shared cache area 22 is copied automatically to area 32, in the new version shared cache area 28, where it is recorded as change information.

During the data migration conversion step 70, create replay information function 14b accesses change information in area 32 of the new version shared cache area 28 and creates replay information. The replay information defines the changes to the data of the new version data store 18 that are required to correspond to changes made to the data of the existing version data store 6 taking into account the differences in the logical structures or schema of the two data stores. The replay information may be stored, for example as a log of all updates to be made to the new version data store 18.

An example of the transformation performed by create replay information function 14b during the data migration conversion step 70 to transform change information, relating to the changes in the existing version data store 6 made available to the new version software program 14 by the shared cache functionality, to replay information, which effects corresponding changes to the new version data store 18, in the context of a radio communication network will now be given.

In the example we assume that existing version data store 6 is a database having a table named UtranCell with attributes (columns): Id, Frequency, Location and Operational State.

New version data store 18 has a table named UtranCell with attributes (columns): Id, Low Band Frequency, High Band Frequency, Power Level, Location and Operational State. Thus it can be seen that the data store schema has changed: the new version data store has different attributes on frequency and added new functionality through attribute Power Level.

At the start of the data migration phase it is assumed that there are 10 UtranCells in the table.

As indicated above, during the data migration phase, the existing version software program 14 continues working and can update data in the existing version data store 6. The changes are recorded in the area 26 of the existing version shared cache area 22 and automatically copied by shared cache functionality to area 32 of new version shared cache area 28 and stored there as change information. The create replay information function 14b then creates the replay information from the change information. Three exemplary pairs of change information and corresponding replay information are set out below:

### Example 1

Change information: DELETE UtranCell Id=1
Replay information: DELETE UtranCell Id=1

### Example 2

Change information: UPDATE UtranCell Id=2,
   Frequency=1231
Replay information: UPDATE UtranCell Id=2
   Low Band Frequency=31,
   High Band Frequency=12

### Example 3

Change information: CREATE UtranCell 11Frequency=1443,
   Location=London_{—}1,
   Operational State=UP
Replay information: CREATE UtranCell 11
   Low Band Frequency=43,
   High Band Frequency=14,
   Power Level=23 (default value)
   Location=London_{—}1,
   Operational State=UP.

In some embodiments default values to be used in generating replay information when the corresponding information was not captured in the existing version data store schema may be specified. Thus in Example 3a default value for the Power Level is provided in the replay information to be applied to the new version data store since this information was not stored in the existing version database.

In the illustrated embodiment the replay information is stored in area 34 of the new version shared cache area 28, but it will be apparent to a skilled person that it is not necessary for the replay information to be stored in the cache and the replay information could instead be stored in any appropriate store, as will be apparent to a skilled person.

Although the data migration creation step 68 and the data migration conversion step 70 are shown as being carried out simultaneously in the exemplary embodiment, this is not necessary and in some embodiments these activities may be carried out sequentially. In some embodiments a log of change information may be accumulated during the data migration and a the change information in the accumulated log of change information may be transformed into replay information after the data migration has been completed.

Once data migration steps 68 and 70 have been completed, create new data store function 14a has created a new version data store 18 having a new data store schema and being populated with the data from the existing version data store 6 at the beginning of the data migration phase. In addition create replay information function 14b has generated replay information defining the changes to the new version data store 18 that are required to correspond to changes made to the existing version data store 6 since the start of the data migration phase.

Thereafter, in step 72 of method 60, the update function 14c updates the new version data store 18 using the replay information, which in this embodiment is stored in area 34 of the new version shared cache area 28. Once the new version data store 18 has been updated by function 14c using the stored replay information, the data in new version data store 18 is fully up to date. The software update is now complete: so in step 74 of method 60 the status of new version software program 14 is changed to online and the status of existing version software program 2 is changed to offline.

The status of the existing version software program 2 can be changed to off-line in a number of ways. In the exemplary embodiment of the invention, an instruction to go off-line can be sent via the shared cache function 14d and shared cache function 2a.

A detailed explanation of the operation of the embodiment of the invention shown in FIG. 1 will now be described with reference to FIG. 4.

Initially, the existing version software program 2 is in an online state 40. In step 81: Start, the new version software program 14 is installed on the host 16 and starts in the standby state 42.

Next, in step 82: create state (PROG, v2.0, data), the new version software program 14 creates the new version shared cache area 28. As mentioned previously, existing version software program shared cache area 28 contains information relating to the programme identity and version number in area 30.

In step 83: getState, new version software program 14 interrogates shared cache 8 to determine whether a previous version of the program is present. In the present example it is assumed that a previous version of the program is present, and that therefore the update installation method 60 described above will be necessary. Copying of recorded update actions from area 26 of existing version shared cache area 22 to area 32 of new version shared cache area 28 is initiated via the shared cache mechanisms.

In some embodiments the shared cache 8 sends a message to the existing version software program 2, step 84: record actions in cache, to start recording update actions to the existing version data store 6 in the update record area 26. However, in some embodiments of the invention, it is envisaged that the existing version software program 2 will already be recording actions, and therefore it may not be necessary in all embodiments to initiate recording.

Now that the new version software program 14 has established that a previous version of the program exists, the data migration state is entered and the new version software program 14 create an existing version data store copy 36 of data store 6 in step 85: backup. The new version software program 14 also creates the new version data store 18 with a new schema with step 86: create message. At this stage the new version data store 18 is not populated with any data.

The new version software program 14 starts to migrate data from the existing version data store copy 36 to the new version data store 18 in step 87: migrate data.

In the meantime, the existing version software program 2 carries on updating the existing version data store 6 in step 88:change, and records changes made to existing version data store 6 in step 88:change into area 26 of the existing version shared cache area 22 in step 89: update state. In some embodiments, a separate step is not required and the recordal of the action may occur automatically. The shared cache functionality copies information stored in the area 26 of the existing version shared cache area 22 during step 89: update state, to the area 32 of the new version shared cache area 28. As will be apparent to a skilled person, in some implementations step 89 may be carried out as part of step 88. Alternatively during the data store change process 44 it is not always necessary actually to update the data in existing data store 6 in step 88:change, but instead the actions can just be recorded in step 89:update state.

The new version software program 14 is notified of the change information copied to area 32 of the new version shared cache area 28 in step 90: notify change, and the new version software program 14 then creates replay information and stores replay information in area 34 of the new version shared cache area 28 in step 91: store replay actions.

As described previously, in the exemplary embodiment steps 88-91 are repeated until step 87:migrate data has been completed and all of the data stored in the data store copy 36 has been transferred to the new version data store 18.

Once the data migration phase has finished, step 92: migration finished, new version software program 14 enters the replay state 50. In replay state 50, the new version software program 14 retrieves the replay information stored in area 34 of the new version shared cache area 28 in the exemplary embodiment, in step 93: getreplayactions, and updates new version data store 18 using the retrieved replay information in step 94: replayactions.

Once all the replay actions have been completed, the new version data store 18 is fully up to date and fully reflects the up to date data in existing version data store 6. In the exemplary embodiment the new version software program 14 therefore instructs existing version software program 2 to enter the offline state by sending a stop message via the shared cache 8. Thus, in step 95: stopstate (PROG, v1.0) an instruction to stop operation of the existing software program 2 is sent from new version software program 14 using the shared cache functions 2a and 14d. In response, the shared cache function 2a instructs existing version software program 2 to stop operation, in step 96: destroymessage. In some embodiments the shared cache also destroys the existing version shared cache area 22 associated with the existing version software program 2.

In response to the receipt of the instruction from the shared cache 8 in step 96: destroymessage, the existing version software program 2 enters the offline state 54.

The storage used for the existing version data store 6 is no longer required by the existing version software program and could now be used by other processes in host computer 4. Thus in the described embodiment in step 97: destroy message, the new version software program 14 also deletes existing version data store 6.

The existing version software program is no longer operational and new version software program 14 enters the online state 52 and starts operating using the associated new version data store 18.

In the described embodiments the existing version software enters a recording update state 46 during the data store change process 44. However, in other embodiments it is envisaged that a record of the data store updates is already being recorded in the area 26 of the existing version shared cache area 22. In this situation, the shared cache will merely copy new update records from area 26 of the existing version shared cache area 22 to area 32 of the new version shared cache area 28.

In the described embodiments, an area 34 for storing replay information is provided in the new version shared cache area 28. However, it is not necessary to store the replay information in the new version shared cache area 28, and in some embodiments the replay information may be stored in another storage area, as will be apparent to a skilled person.

In the specification the term software or software program is intended to also be applicable to a software program fragment as well as to a complete software program and is intended to mean any set of instructions capable of being followed by a processor.

Thus it can be seen that the present invention provides a new method of updating software using a shared cache.

Modifications and other embodiments of the disclosed invention will come to mind to one skilled in the art having the benefit of the teachings presented in the foregoing description and the associated drawings. Therefore it is to be understood that the invention is not to be limited to specific embodiments disclosed and that modifications and other embodiments are intended to be included within the scope of this disclosure. Although specific terms may be employed herein, they are used in a generic and descriptive sense only and not for the purposes of limitation.

1. A method of replacing existing version software and an associated existing version data store with new version software and an associated new version data store using a shared cache, in which the software is versioned and each version of the software has an associated area within the shared cache for storing data, including at least software identification and version information, the method including a data store change process comprising the steps of:
creating a new version data store, having a new version data store schema, containing data derived from the data in the existing version data store at an initial point at the start of a data migration phase; and
converting change information, stored by the existing version software in the shared cache and relating to changes to the existing version data store made by the existing version software during the step of creating the new version data store, to replay information relating to corresponding changes to the new version data store; and
updating the new version data store using the replay information during a replay phase of the data store change process.

2. The method as claimed in claim 1 further comprising the step, in an initial standby phase, of:
creating a cache area for storing at least software identification and version information data.

3. The method as claimed in claim 1 further comprising the step, in an initial standby phase, of:
detecting whether an existing version of the software is present by determining whether an area having the same identification information and different version information is present;
and if an existing version of the software is detected, further comprising the step of
creating the shared cache with the existing version of the software; and
initiating a data store change process.

4. The method as claimed in claim 1 further comprising the step of instructing, via shared cache instructions, the existing version software to record change information relating to data change actions, made in the existing version data store, in the existing version shared cache area.

5. The method as claimed claim 1 also comprising the step of:
instructing the shared cache to replicate change information subsequently added to the existing version shared cache area to the new version shared cache area.

6. The method as claimed in claim 5 further comprising the step of accessing the new version shared cache area to obtain the change information relating to changes to the data in the existing version data store made by the existing version software during the data migration phase.

7. The method as claimed in claim 1 comprising the steps of:
creating a change area in the new version shared cache area; and
instructing the shared cache to replicate change information subsequently added to the existing version shared cache area to the change area in the new version shared cache area.

8. The method as claimed in claim 1, further comprising the step of storing replay information in a replay area of the new version shared cache area.

9. The method as claimed in claim 1, wherein once the data store change process is completed by updating the new version data store with the replay information accumulated during the data migration phase, the method further comprises the steps of:
changing the status of the existing version software to offline; and
removing all data structures associates with the existing version software.

10. The method as claimed in claim 9 further comprising the step of using shared cache instructions to change status of existing version software to offline.

11. The method as claimed in claim 1 wherein once the data store change process is completed by updating the new version data store with the replay information, the method further comprises the steps of:
changing the status of the new version software to online.

12. A machine-readable medium comprising instructions which cause a processor to perform a method of replacing existing version software and an associated existing version data store with new version software and an associated new version data store using a shared cache, in which the software is versioned and each version of the software has an associated area within the shared cache for storing data, including at least software identification and version information, the method including a data store update process comprising the steps of:
creating a new version data store, having a new version data store schema, containing data derived from the data in the existing version data store at an initial point at the start of a data migration phase; and
converting change information, stored by the existing version software in the shared cache and relating to changes to the existing version data store made by the existing version software during the step of creating the new version data store, to replay information relating to corresponding changes to the new version data store; and
updating the new version data store using the replay information during a replay phase of the data store change process.

13. A machine readable medium as claimed in claim 12 also comprising instructions which cause the processor to perform the steps in an initial standby phase, of:
detecting whether an existing version of the software is present by determining whether an area having the same identification information and different version information is present;
and if an existing version of the software is detected, further comprising the step of
creating the shared cache with the existing version of the software; and
initiating a data store change process.

14. A network element having:
a versioned software program stored on a machine-readable medium;
a data store associated with the versioned software program stored on a storage medium; and
a cache area associated with the software program formed on a cache storage medium, the cache area having data, including at least software identification and version information of the associated software program, stored therein and the cache area being part of a shared cache:
where the versioned software comprises the following functions that are operable during a data store change process of a method of replacing existing version software and an associated existing version data store with the versioned software program and the data store associated with the versioned software program:
create new data store function operable to create the data store, the data store having a data store schema, the data store containing data derived from the data in the existing version data store at an initial point at the start of a data migration phase;
create replay information function operable to convert change information, stored by the existing version software in the shared cache and relating to changes to the existing version data store made by the existing version software during the step of creating the data store, to replay information relating to corresponding changes to the data store; and
update data store function operable to update the data store using the replay information during a replay phase of the data store change process.

15. A network element as claimed in claim 14 wherein the versioned software program also comprises:
a shared cache function operable to detect whether an existing version of the software is present by determining whether an area having the same identification information and different version information is present and if an existing version of the software is detected, operable to create the shared cache with a corresponding shared cache function of the existing version of the software.
